(19) United States
(12) Patent Application Publication
(10) Pub. No.: US 2026/0051433 A1
(43) Pub. Date: Feb. 19, 2026

(54) COIL COMPONENT

(71) Applicant: TDK Corporation, Tokyo (JP)

(72) Inventors: Shinnosuke SUZUKI, Tokyo (JP); Kazuya TOBITA, Tokyo (JP); Munehiro TAKAKU, Tokyo (JP); Tomohiro KAITO, Tokyo (JP)

(73) Assignee: TDK Corporation, Tokyo (JP)

(21) Appl. No.: 19/296,346

(22) Filed: Aug. 11, 2025

(30) Foreign Application Priority Data
Aug. 13, 2024 (JP) 2024-135055

(51) Int. Cl. H01F 27/02; H01F 27/28; H01F 27/32

(52) U.S. Cl. CPC H01F 27/022; H01F 27/2804; H01F 27/324; H01F 2027/2809

(57) ABSTRACT

In the coil component, the facing surface of each of the second wiring portions is visible when viewed from the main surface side of the element body. Since the color of the colored layer provided on the facing surface is different from the color of the main body, the first region where the colored layer is provided and the second region where the main body is exposed from the colored layer can be distinguished from each other when viewed from the main surface side of the element body. By forming various characteristic patterns by combining the first region and the second region, various identification information can be given to the coil component, and the identifiability of the coil component can be acquired.

### CROSS-REFERENCE TO RELATED APPLICATIONS

This application is based upon and claims the benefit of priority from Japanese Patent Applications No. 2024-135055, filed on 13 Aug. 2024, the entire content of which is incorporated herein by reference.

### TECHNICAL FIELD

The present disclosure relates to a coil component.

### BACKGROUND

Japanese Patent Application Publication No. 2014-232815 discloses a coil component including an element body having a laminated structure composed of a plurality of insulating layers, and a coil conductor provided in the element body.

### SUMMARY

In the coil component described above, there is no feature in the appearance thereof, and it has been difficult to identify the coil component from the appearance. The inventors have studied identification of a coil component from the appearance thereof, and as a result, have newly found a technology that allows the coil component to be identified from the appearance thereof.

According to aspects of the present disclosure, there is provided a coil component identified from the appearance thereof.

A coil component according to one aspect of the present disclosure includes an element body having a light transmissive property and including a plurality of laminated insulating layers, and a coil conductor provided in the element body and having a visible surface facing a surface side of the element body and is visible from the surface. The coil conductor includes a main body and a colored layer having a color different from a color of the main body and provided on a part of the visible surface, and there exist a first region and a second region in the visible surface. The colored layer is provided at the first region, and the main body is exposed from the colored layer at the second region.

In the above coil component, the element body has a light transmissive property, and on the visible surface of the coil conductor visible from the surface of the element body, there exist the first region where the colored layer is provided and the second region where the main body of the coil conductor is exposed from the colored layer. In this case, the first region and the second region of the visible surface of the coil conductor can be visible from the appearance of the coil component, and a combination of the first region and the second region on the visible surface provides identifiability.

### BRIEF DESCRIPTION OF THE DRAWINGS

FIG. 1 is a perspective view of a coil component according to one embodiment.

FIG. 2 is a perspective view of the coil conductor shown in FIG. 1.

FIG. 3 is an exploded perspective view of the configuration of each layer of the coil component shown in FIG. 1.

FIG. 4 shows the configuration of the wiring portion of the first element layer shown in FIG. 3.

FIG. 5 is a cross-sectional view taken along line V-V of the second wiring portion shown in FIG. 4.

FIG. 6 shows the configuration of the wiring portion of the second element layer shown in FIG. 3.

FIG. 7 shows the configuration of the wiring portion of the third element layer shown in FIG. 3.

FIG. 8 shows the configuration of the wiring portion of the fourth element layer shown in FIG. 3.

FIG. 9 shows the configuration of the wiring portion of the fifth element layer shown in FIG. 3.

FIG. 10 is a flowchart of the procedure of the method for manufacturing the coil component shown in FIG. 1.

FIG. 11 is a side view of the coil component shown in FIG. 1.

FIG. 12 is a plan view of the element body when viewed from a side opposite to the mounting surface.

FIG. 13 shows a coil component having a different configuration.

FIG. 14 shows a coil component having a different configuration.

### DETAILED DESCRIPTION

Hereinafter, embodiments of the present disclosure will be described in detail with reference to the accompanying drawings. In the description of the drawings, the same or corresponding element is denoted by the same reference numeral, and redundant description is omitted.

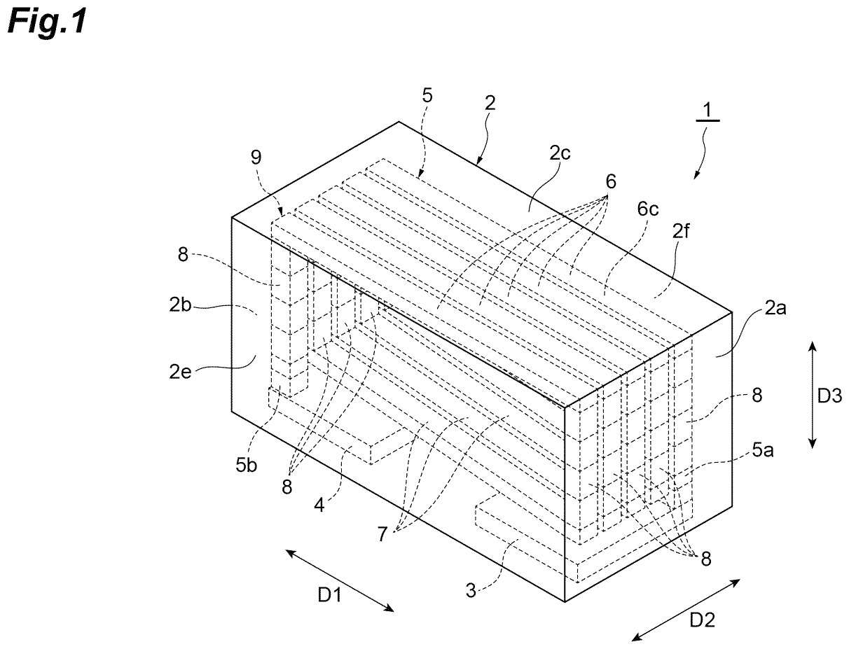

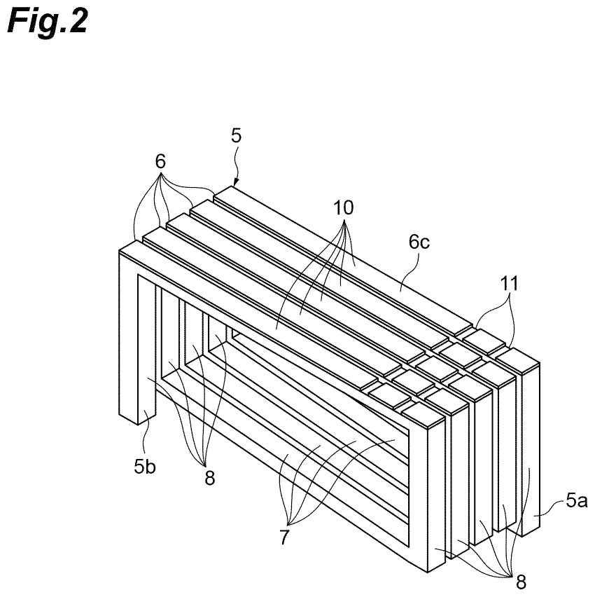

A coil component according to the present embodiment will be described with reference to FIG. 1. As shown in FIGS. 1 and 2, a coil component 1 according to one embodiment includes an element body 2, a pair of bottom electrodes 3 and 4, and a coil conductor 5. The coil conductor 5 is provided in the element body 2 and includes a plurality of second wiring portions 6, a plurality of pairs of pillar portions 8, and a plurality of first wiring portions 7, as will be described later. In particular, the coil conductor 5 includes five of the second wiring portions 6, five pairs of the pillar portions 8, and four of the first wiring portions 7. The coil conductor 5 has a coil axis along a second direction D2 to be described later, and is wound around the coil axis. The coil conductor 5 according to the present embodiment is wound around the coil axis by about 4.5 turns. The number of turns of the coil conductor 5 can be increased or decreased as appropriate. Accordingly, the number of the pairs of the pillar portions 8, the number of the first wiring portions 7, and the number of the second wiring portions 6 may also be increased or decreased.

The element body 2 has a rectangular parallelepiped shape. The rectangular parallelepiped shape includes a rectangular parallelepiped shape in which a corner portion and a ridge portion are chamfered or rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, the facing direction of the end surfaces 2a and 2b is a first direction D1, the facing direction of the side surfaces 2e and 2f is a second direction D2, and the facing direction of the main surfaces 2c and 2d is a third direction D3. The first direction D1, the third direction D3, and the second direction D2 are substantially orthogonal to each other.

The end surfaces 2a and 2b extend in the third direction D3 to connect the main surfaces 2c and 2d. The end surfaces 2a and 2b also extend in the second direction D2 to connect the side surfaces 2e and 2f. The main surfaces 2c and 2d extend in the first direction D1 to connect the end surfaces 2a and 2b. The main surfaces 2c and 2d also extend in the second direction D2 to connect the side surfaces 2e and 2f. The side surfaces 2e and 2f extend in the first direction D1 to connect the end surfaces 2a and 2b. The side surfaces 2e and 2f also extend in the third direction D3 to connect the main surfaces 2c and 2d.

The main surface 2d is a mounting surface of the element body 2, and is, for example, a surface facing another electronic device when the coil component 1 is mounted on another electronic device (not shown) (for example, a circuit substance or a laminated electronic component). The end surfaces 2a and 2b are continuous surfaces from the mounting surface (i.e., the main surface 2d).

The length of the element body 2 in the first direction D1 is longer than the lengths of the element body 2 in the third direction D3 and the second direction D2. The length of the element body 2 in the third direction D3 is shorter than the length of the element body 2 in the second direction D2. That is, in the present embodiment, each of the end surfaces 2a and 2b, the main surfaces 2c and 2d, and the side surfaces 2e and 2f has a rectangular shape. The length of the element body 2 in the third direction D3 may be comparable with the length of the element body 2 in the second direction D2 or may be longer than the length of the element body 2 in the second direction D2.

In the present embodiment, the term “comparable” may refer to a value including a slight difference or a manufacturing error within a predetermined range, in addition to being equal. For example, when values are included in a range of ±5% of an average value of the values, the values are defined as being comparable.

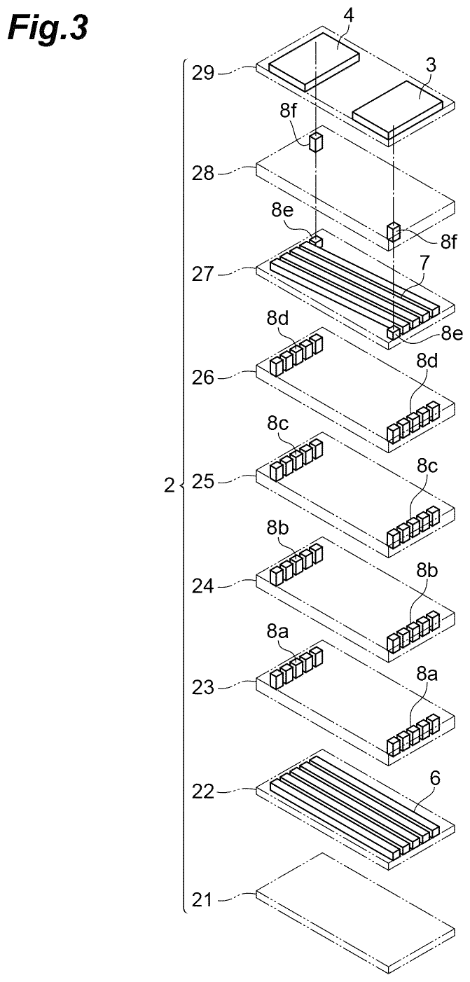

As shown in FIG. 3, the element body 2 has a configuration in which a plurality of element layers (insulating layers) are laminated in the third direction D3. In the present embodiment, the element body 2 is composed of nine of element layers 21 to 29. That is, the lamination direction of the element body 2 coincides with the third direction D3. The wiring portions 6 and 7 and wiring portions 8a to 8f constituting the coil conductor 5 are embedded in the element layers 22 to 28. As described in the manufacturing method below, the element body 2 can be manufactured by sequentially laminating the element layers 22 to 29 on the element layer 21. In the actual element body 2, the element layers 21 to 29 may be integrated so that the interface between the layers is visible or not visible to some extent.

Each of the element layers 21 to 29 is mainly composed of insulating material, and is composed of a light-transmissive resin material in the present embodiment. The resin material includes, for example, at least one selected from a liquid crystal polymer, a polyimide resin, a crystalline polystyrene, an epoxy-based resin, an acrylic-based resin, a bismaleimide-based resin, and a fluorine-based resin. The resin material may or may not contain a filler. The filler is, for example, an inorganic filler. The inorganic filler is silica. Each of the wiring portions 6, 7, and 8a to 8f is composed of a conductive material (for example, Cu).

The element layer 21 is composed only of the insulating material. The element layer 21 is located in the lowest layer of the element body 2 and constitutes the main surface 2c.

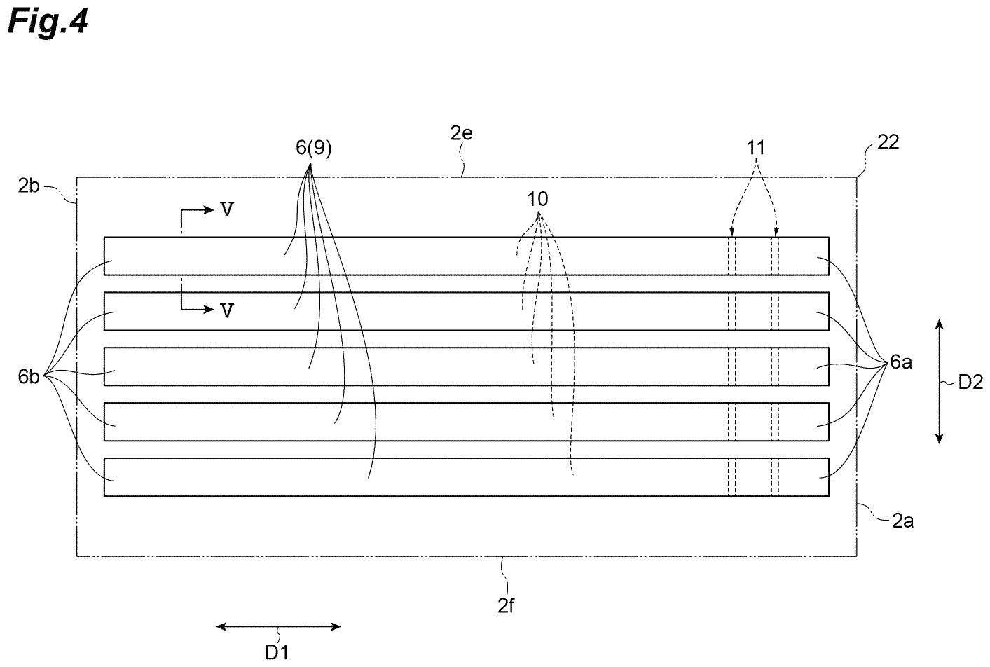

As shown in FIGS. 3 and 4, the second wiring portions 6 (lower wiring portions) are embedded in the element layer 22, and the element layer 22 according to the present embodiment includes five of the second wiring portions 6. Each of the second wiring portions 6 extends in parallel along the first direction D1 and has the same length with respect to the first direction D1. The second wiring portions 6 are equally spaced with respect to the second direction D2. The second wiring portions 6 are spaced from the end surfaces 2a and 2b and the side surfaces 2e and 2f of the element body 2. One end portion 6a in the extending direction of each of the second wiring portions 6 is located near the end surface 2a, and the other end portion 6b is located near the end surface 2b. The second wiring portions 6 are located on the main surface 2c side of the element body 2 because the element layer 22 is laminated directly on the element layer 21 constituting the main surface 2c. Hereinafter, the element layer 22 is also referred to as a first element layer.

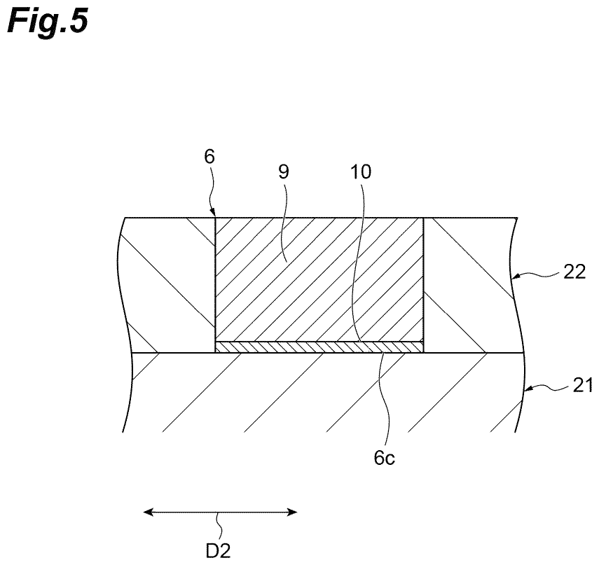

As shown in FIG. 5, each of the second wiring portions 6 has a substantially rectangular cross-sectional shape in a cross section orthogonal to the extending direction (i.e., the first direction D1). Each of the second wiring portions 6 also includes a main body 9 and a colored layer 10 in the cross section orthogonal to the extending direction. The main body 9 has a substantially rectangular cross-sectional shape and is composed of metal material. In particular, the main body 9 is made of Cu, and is composed of Cu plating in particular. The colored layer 10 is interposed at an interface between the main body 9 and the element layer 21. The colored layer 10 is a thin layer and is composed of metal material. In the present embodiment, the colored layer 10 is made of Cr and has a color different from the color of the main body 9 made of Cu. The colored layer 10 can be made of a material having a higher adhesive force to the element layer 21 than a constituent material of the main body 9. In this case, by interposing the colored layer 10 at the interface between the main body 9 and the element layer 21, the adhesive force of the second wiring portion 6 to the element layer 21 is enhanced as compared with a case where the colored layer 10 is not interposed. When the main body 9 is formed by electrolytic plating, the colored layer 10 can be used as a seed layer. At that time, if necessary, a coating layer covering a surface of the colored layer 10 may be formed by Cu sputtering.

Each of the second wiring portions 6 has a facing surface 6c (visible surface) facing the main surface 2c side of the element body 2. On the facing surface 6c of at least one of the second wiring portions 6, there exist a first region R1 and a second region R2. In the first region R1, the colored layer 10 is provided. In the second region R2, the main body 9 is exposed from the colored layer 10. In the present embodiment, the first region R1 exists over substantially the entire surface of all of the second wiring portions 6, and the second region R2 also exists in a part of all of the second wiring portions 6. Specifically, across the second wiring portions 6, two slits 11 where the colored layer 10 is not present extend along the second direction D2 near the end portions 6a, and formation regions of the slits 11 serves as the second regions R2 where the main body 9 is exposed from the colored layer 10. In the facing surface 6c, a region other than the formation regions of the slits 11 (remaining regions) serves as the first region R1 where the colored layer 10 is provided.

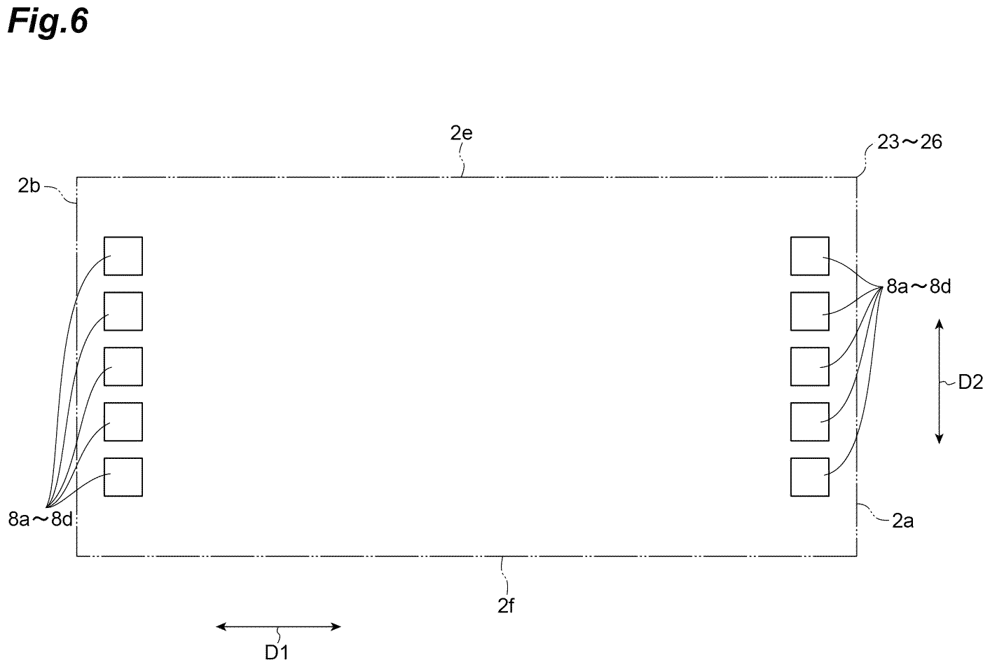

In the element layers 23 to 26, as shown in FIGS. 3 and 6, wiring portions 8a to 8d (pillar conductors) constituting the pillar portion 8 extending along the third direction D3 are embedded. The wiring portions 8a to 8d are provided at the same position in each of the element layers 23 to 26 and overlap each other in the third direction D3. Hereinafter, the element layers 23 to 26 are also referred to as second element layers.

Each of the wiring portions 8a to 8d is composed of a plurality of pairs with respect to the first direction D1, and is composed of five pairs in the present embodiment. In particular, each of the wiring portions 8a to 8d is aligned in two rows along the second direction D2 and are equally spaced with respect to the second direction D2. Hereinafter, of the wiring portions 8a to 8d aligned in two rows, the row on the end surface 2a side is also referred to as a first row 8A, and the row on the end surface 2b side is also referred to as a second row 8B. The wiring portions 8a to 8d at the first row 8A are arranged at positions corresponding to the end portions 6a of the second wiring portions 6, and the wiring portions 8a to 8d at the second row 8B are arranged at positions corresponding to the end portions 6b of the second wiring portions 6. In the present embodiment, each of the wiring portions 8a to 8d has a substantially rectangular shape (for example, a substantially square shape) when viewed from the third direction D3. Each of the wiring portions 8a to 8d may have a circular shape, an elliptical shape, or a polygonal shape other than a square shape when viewed from the third direction D3.

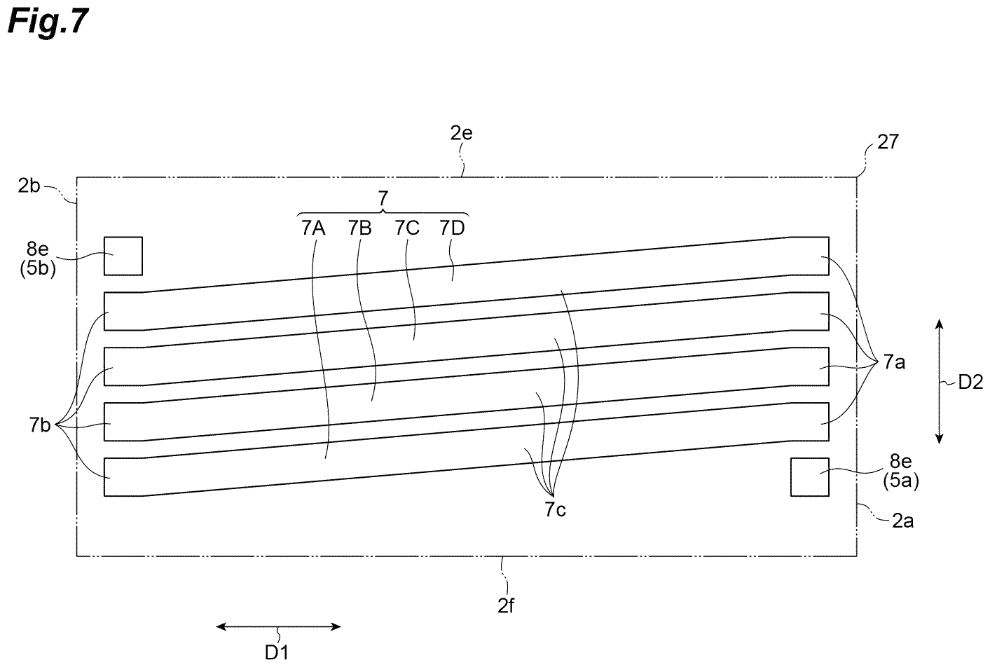

In the element layer 27, as shown in FIGS. 3 and 7, a plurality of first wiring portions 7 are embedded, and the element layer 27 includes four of the first wiring portions 7 in the present embodiment. Hereinafter, the element layer 27 is also referred to as a third element layer. Each of the first wiring portions 7 has a pair of the end portions 7a and 7b, and an inclined portion 7c interposed between the pair of the end portions 7a and 7b. The pair of the end portions 7a and 7b and the inclined portion 7c are configured to be continued, and the pair of the end portions 7a and 7b are located on both sides of the inclined portion 7c with respect to the first direction D1. The pair of the end portions 7a and 7b are composed of a first end portion 7a located closer to the end surface 2a of the element body 2, and a second end portion 7b located closer to the end surface 2b of the element body 2. The pair of the end portions 7a and 7b are offset from each other with respect to the second direction D2 when viewed from the third direction D3. In the present embodiment, the first end portion 7a is located closer to the side surface 2f than the second end portion 7b when viewed from the third direction D3. The inclined portion 7c extends in a direction inclined at a predetermined angle with respect to the first direction D1 and connects the pair of the end portions 7a and 7b that are offset from each other with respect to the second direction D2. The inclination angle with respect to the first direction D1 is the same for all the first wiring portions 7. That is, the inclined portions 7c of the first wiring portions 7 have a parallel relationship with each other. In the present embodiment, four of the first wiring portions 7 are composed of a first wiring portion 7A, a first wiring portion 7B, a first wiring portion 7C, and a first wiring portion 7D arranged in order from the side closer to the side surface 2f.

The first end portion 7a of the first wiring portion 7 overlaps with one of the wiring portions 8a to 8d at the first row 8A and one end portion 6a of one of the second wiring portions 6 when viewed from the third direction D3. The second end portion 7b of the first wiring portion 7 overlaps with one of the wiring portions 8a to 8d at the second row 8B and one end portion 6b of one of the second wiring portions 6 when viewed from the third direction D3. In the present embodiment, the second end portion 7b of the first wiring portion 7A overlaps with the first of the wiring portions 8a to 8d at the second row 8B counted from the side surface 2f side and overlaps with the end portion 6b of the first of the second wiring portions 6 counted from the side surface 2f side, and the first end portion 7a overlaps with the second of the wiring portions 8a to 8d at the first row 8A counted from the side surface 2f side and overlaps with the end portion 6a of the second of the second wiring portions 6 counted from the side surface 2f side. The second end portion 7b of the first wiring portion 7B overlaps with the second of the wiring portions 8a to 8d at the second row 8B counted from the side surface 2f side and overlaps with the end portion 6b of the second of the second wiring portions 6 counted from the side surface 2f side, and the first end portion 7a overlaps with the third of the wiring portions 8a to 8d at the first row 8A counted from the side surface 2f side and overlaps with the end portion 6a of the third of the second wiring portions 6 counted from the side surface 2f side. The second end portion 7b of the first wiring portion 7C overlaps with the third of the wiring portions 8a to 8d at the second row 8B counted from the side surface 2f side and overlaps with the end portion 6b of the third of the second wiring portions 6 counted from the side surface 2f side, and the first end portion 7a overlaps with the fourth of the wiring portions 8a to 8d at the first row 8A counted from the side surface 2f side and overlaps with the end portion 6a of the fourth of the second wiring portions 6 counted from the side surface 2f side. The second end portion 7b of the first wiring portion 7D overlaps with the fourth of the wiring portions 8a to 8d at the second row 8B counted from the side surface 2f side and overlaps with the end portion 6b of the fourth of the second wiring portions 6 counted from the side surface 2f side, and the first end portion 7a overlaps with the fifth of the wiring portions 8a to 8d at the first row 8A counted from the side surface 2f side and overlaps with the end portion 6a of the fifth of the second wiring portions 6 counted from the side surface 2f side.

Further, a pair of wiring portions 8e (first extracting wiring portions) are embedded in the element layer 27. One of the pair of the wiring portions 8e is provided at a position overlapping one of the wiring portions 8a to 8d at the first row 8A, and the other of the pair of the wiring portions 8e is provided at a position overlapping one of the wiring portions 8a to 8d at the second row 8B. In the present embodiment, one of the pair of the wiring portions 8e overlaps with the first of the wiring portions 8a to 8d at the first row 8A counted from the side surface 2f side and overlaps with the end portion 6a of the first of the second wiring portions 6 counted from the side surface 2f side, and constitutes an end portion 5a of the coil conductor 5. The other of the pair of the wiring portions 8e overlaps with the fifth of the wiring portions 8a to 8d at the second row 8B counted from the side surface 2f side and overlaps with the end portion 6b of the fifth of the second wiring portions 6 counted from the side surface 2f side, and constitutes an end portion 5b of the coil conductor 5.

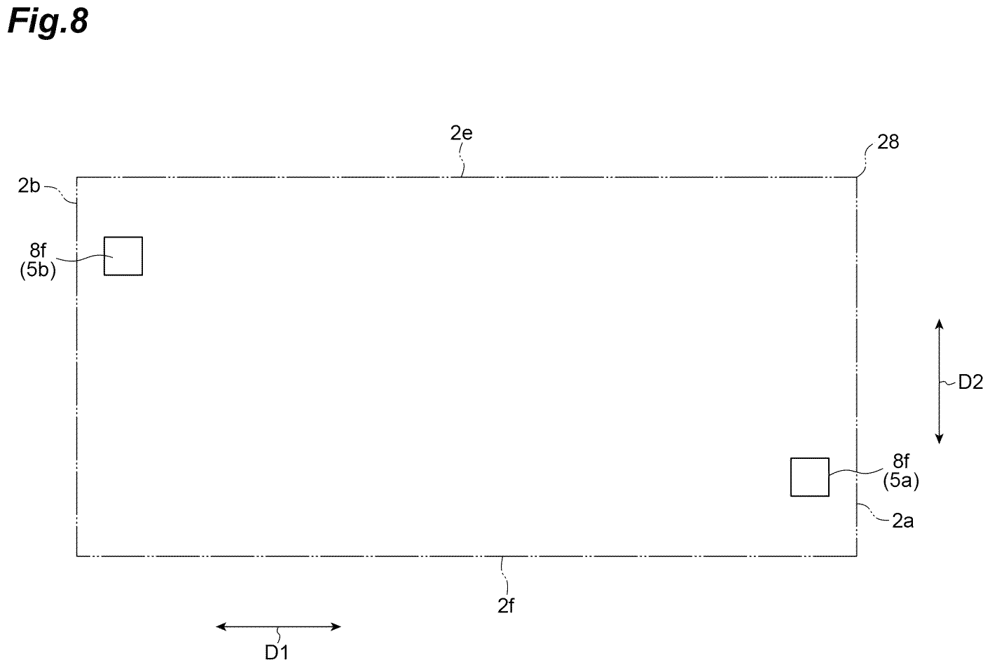

As shown in FIGS. 3 and 8, a pair of the wiring portions 8f (second extracting wiring portions) are embedded in the element layer 28. The pair of wiring portions 8f are provided at positions respectively overlapping the pair of the wiring portions 8e of the element layer 27. The wiring portion 8f on the end surface 2a side and the side surface 2f side constitutes the end portion 5a of the coil conductor 5, and the wiring portion 8f on the end surface 2b side and the side surface 2e side constitutes the end portion 5b of the coil conductor 5. Hereinafter, the element layer 28 is also referred to as a fourth element layer.

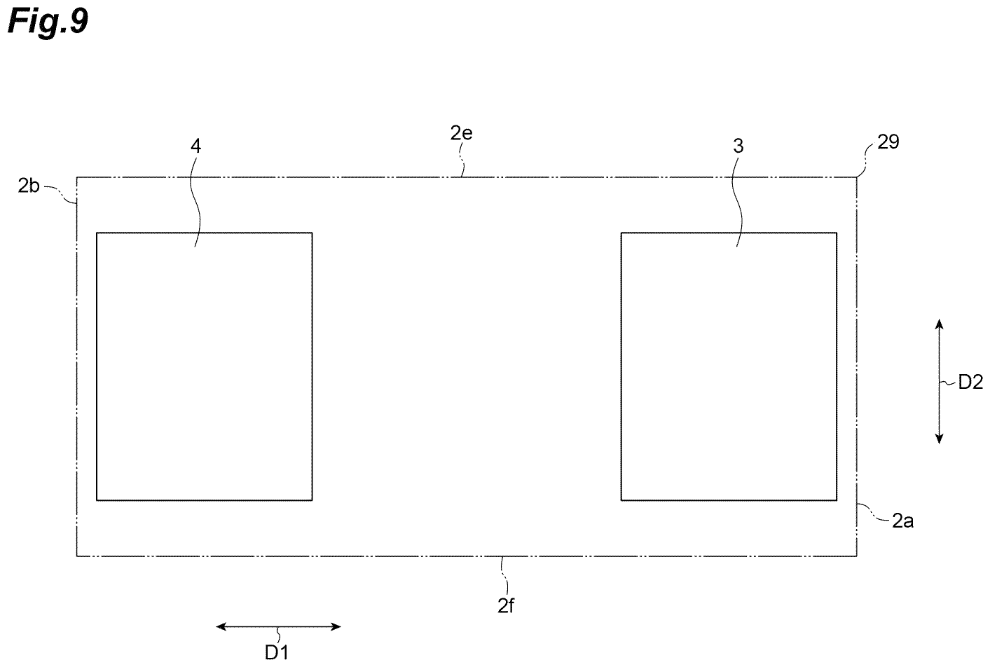

As shown in FIGS. 3 and 9, the pair of the bottom electrodes 3 and 4 (terminal electrodes) are provided in the element layer 29. The element layer 29 is located at the top of the element body 2 in view of the manufacturing procedure, and the element layer 29 constitutes the main surface 2d. In other words, the pair of the bottom electrodes 3 and 4 are provided in the main surface 2d of the element body 2. Hereinafter, the element layer 29 is also referred to as a fifth element layer. Each of the pair of the bottom electrodes 3 and 4 has a rectangular shape when viewed from the third direction D3. The pair of the bottom electrodes 3 and 4 may have the same shape and the same dimensions. The pair of the bottom electrodes 3 and 4 according to the present embodiment are arranged in the first direction D1, the bottom electrode 3 located on the end surface 2a side of the element body 2 overlaps with the wiring portion 8f in the element layer 28 closer to the end surface 2a and the side surface 2f, and the bottom electrode 4 located on the end surface 2b side of the element body 2 overlaps with the wiring portion 8f in the element layer 28 closer to the end surface 2b and the side surface 2e. The pair of the bottom electrodes 3 and 4 are embedded in the element body 2 (in particular, inside the element layer 29) and are exposed from the main surface 2d. A part or a whole of the pair of bottom electrodes 3 and 4 may be provided in the main surface 2d of the element body 2.

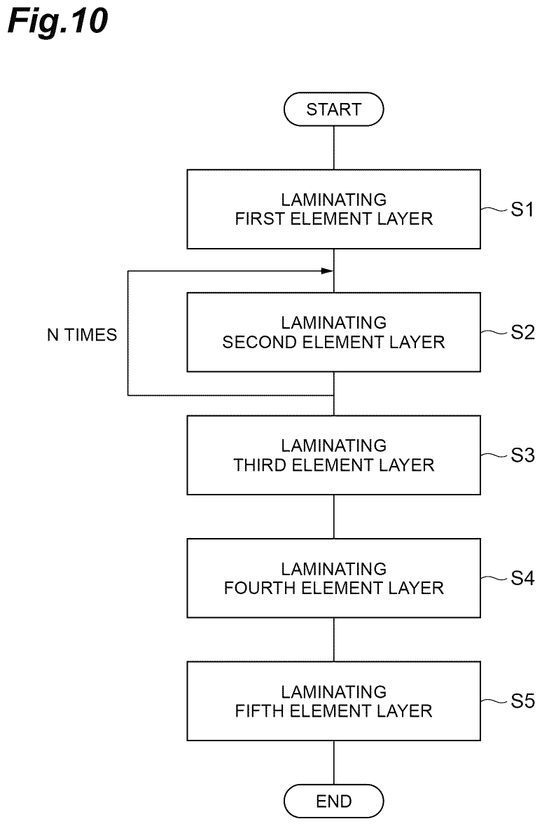

The coil component 1 can be manufactured by the manufacturing method shown in the flowchart of FIG. 10.

First, the first element layer 22 is laminated on the element layer 21 as a first step S1. In particular, the second wiring portions 6 are formed on the element layer 21, and then the second wiring portions 6 are embedded with a resin material constituting the first element layer 22. In particular, predetermined resist partition walls are provided on the element layer 21, the main body 9 is formed by electrolytic plating using the colored layer 10 as a seed layer between the resist partition walls, and then the resist partition walls are removed to obtain the second wiring portions 6.

Next, as a second step S2, the second element layers 23 to 26 are sequentially laminated on the first element layer 22. When the second element layers 23 to 26 are composed of a plurality of layers as in the present embodiment, the second step S2 is repeated a plurality of times. That is, when the number of the second element layers is N, the second step S2 is repeated N times. When the second element layer is a single layer, the second step S2 is performed only once and does not need to be repeated.

Thereafter, as a third step S3, the third element layer 27 is laminated on the second element layers 23 to 26 (in particular, on the second element layer 26 located at the top). Further, as a fourth step S4, the fourth element layer 28 is laminated on the third element layer 27. Finally, as a fifth step S5, the fifth element layer 29 is laminated on the fourth element layer 28. The bottom electrodes 3 and 4 may be provided in the fifth element layer 29 before the fifth element layer 29 is laminated, or may be provided in the fifth element layer 29 after the fifth element layer 29 is laminated.

Next, the pillar portion 8 according to the present embodiment will be described with reference to FIGS. 1, 2, and 11.

In the present embodiment, the pillar portion 8 is formed by stacking the wiring portions 8a to 8d of each of the element layers 23 to 26. The pillar portion 8 is composed of a plurality of pairs along the first direction D1, and is composed of five pairs in the present embodiment. Five pairs of the pillar portions 8 are aligned in two rows of the first row 8A and the second row 8B along the second direction D2, same as the wiring portions 8a to 8d.

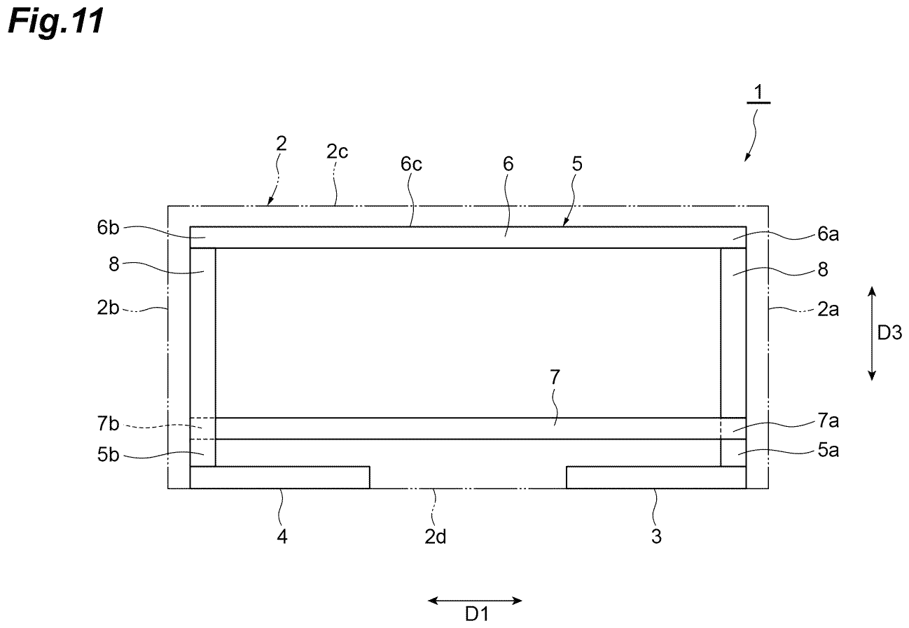

As shown in FIG. 11, each of the pillar portions 8 is connected to both of the end portions 6a and 6b of the second wiring portion 6. In particular, the end portion 6a of the second wiring portion 6 is connected to one end portion of the pillar portions 8 (end portion on the main surface 2c side), and the end portion 6b of the second wiring portion 6 is also connected to one end portion of the pillar portion 8 (end portion on the main surface 2c side). Each of the pillar portions 8 extends from both of the end portions 6a and 6b of the second wiring portion 6 toward the main surface 2d of the element body 2. In other words, one of the second wiring portions 6 is bridged between two of the pillar portions 8.

In the present embodiment, in the first of the pillar portions 8 at the first row 8A counted from the side surface 2f side, one end portion is connected to the end portion 6a of the first of the second wiring portions 6 counted from the side surface 2f side, and the other end portion is connected to the bottom electrode 3 provided in the main surface 2d via the wiring portions 8e and 8f constituting the end portion 5a of the coil conductor 5. In the second to the fifth of the pillar portions 8 at the first row 8A counted from the side surface 2f side, one end portion is respectively connected to the end portions 6a of the second to fifth of the second wiring portions 6 counted from the side surface 2f side, and the other end portion is respectively connected to the first end portions 7a of the first to fourth of the first wiring portions 7 counted from the side surface 2f side.

In the present embodiment, in the first to the fourth of the pillar portions 8 at the second row 8B counted from the side surface 2f side, one end portion is respectively connected to the end portions 6b of the first to the fourth of the second wiring portions 6 counted from the side surface 2f side, and the other end portion is respectively connected to the second end portions 7b of the first to the fourth of the first wiring portions 7 counted from the side surface 2f side. In the fifth of the pillar portions 8 at the second row 8B counted from the side surface 2f side, one end portion is connected to the end portion 6b of the fifth of the second wiring portions 6 counted from the side surface 2f side, and the other end portion is connected to the bottom electrode 4 provided in the main surface 2d via the wiring portions 8e and 8f constituting the end portion 5b of the coil conductor 5.

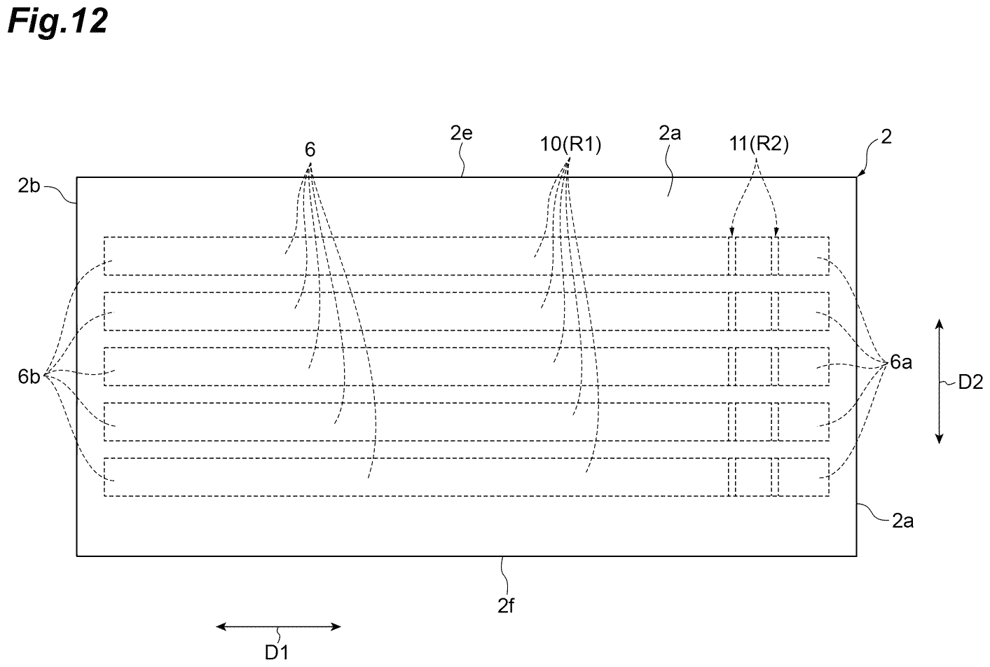

Here, an appearance of the element body 2 of the coil component 1 will be described with reference to FIG. 12. The element body 2 according to the present embodiment is composed of a light-transmissive resin material, and therefore, the coil conductor 5 provided inside the element body 2 can be visually recognized from the surface side of the element body 2. Specifically, as shown in FIG. 12, the second wiring portions 6 constituting a part of the coil conductor 5 are visually recognized when viewed from the main surface 2c side of the element body 2. In particular, each of the facing surfaces 6c of the second wiring portions 6 is visually recognized when viewed from the main surface 2c side of the element body 2.

Since the color of the colored layer 10 provided on the facing surface 6c is different from the color of the main body 9, the first region R1 where the colored layer 10 is provided and the second region R2 where the main body 9 is exposed from the colored layer 10 can be distinguished when viewed from the main surface 2c side of the element body 2. In the present embodiment, the second regions R2 having two slit-shaped provided on the end portion 6a side of each of the second wiring portions 6 are visually recognized when viewed from the main surface 2c side of the element body 2.

By forming various characteristic patterns by combining the first region R1 and the second region R2, various identification information (for example, information on component characteristics, information on component orientation, and the like) can be given to the coil component 1, and identifiability of the coil component 1 can be acquired.

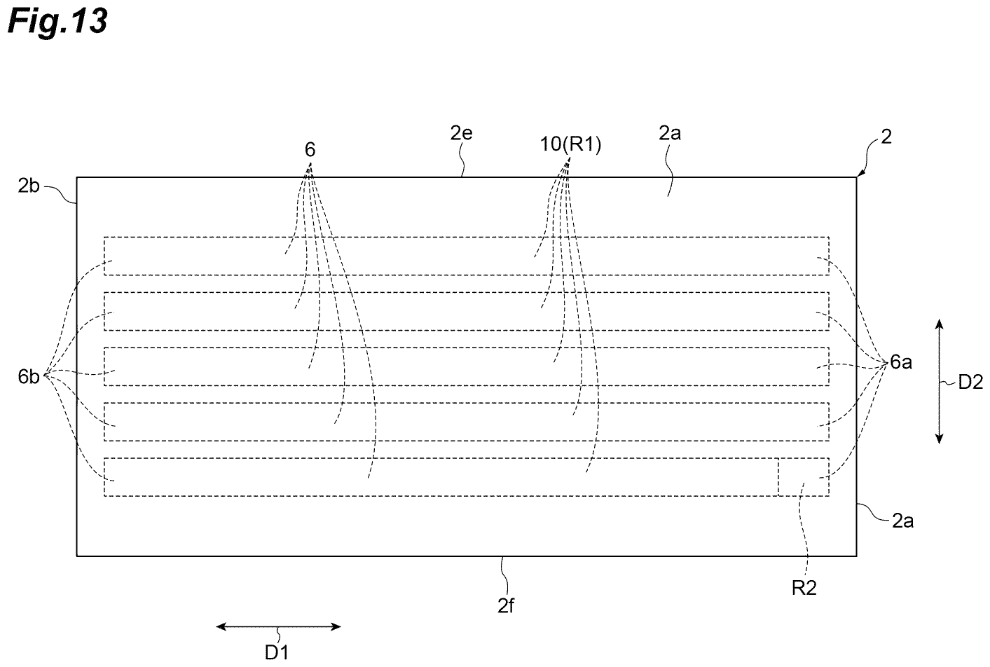

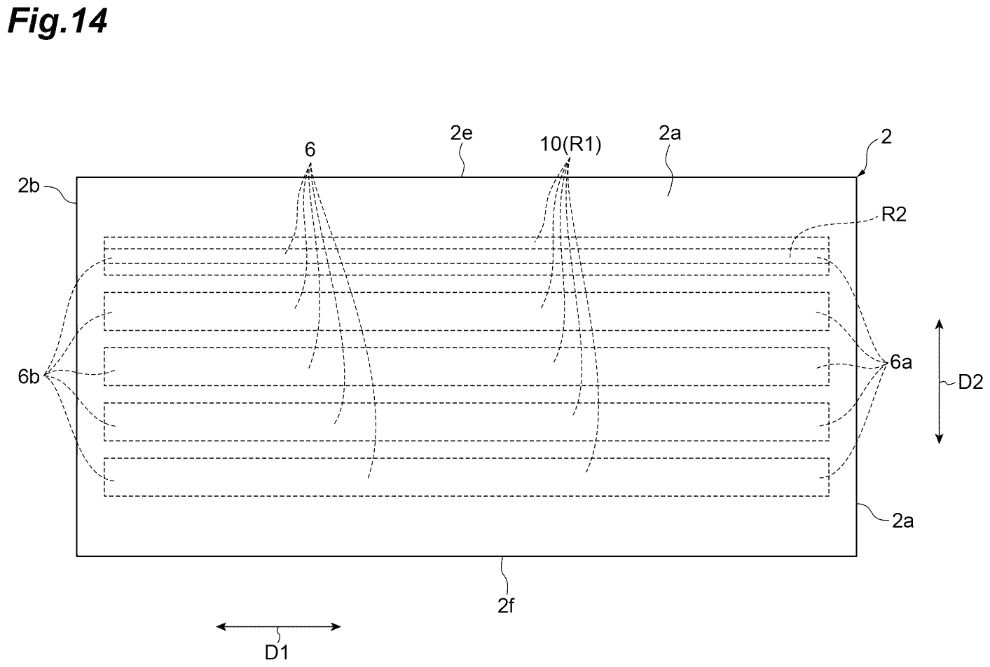

The characteristic pattern formed by the combination of the first region R1 and the second region R2 is not limited to the above-described pattern, and can be variously changed. For example, the second region R2 may extend along the second direction D2 and cross the first region R1, or may terminate in the middle of crossing the first region R1. The second region R2 may exist at positions corresponding to each of the facing surfaces 6c across all the facing surfaces 6c of the second wiring portions 6, or may exist on some of the facing surfaces 6c of the second wiring portions 6. For example, as shown in FIG. 13, the second region R2 may exist only at the end portion 6a of one of the second wiring portions 6, and all other regions may be the first region R1. The second region R2 does not necessarily need to extend in a direction intersecting the extending direction of the second wiring portion 6 (i.e., the first direction D1), and as shown in FIG. 14, the second region R2 may extend in parallel to the extending direction of the second wiring portion 6. In the configuration shown in FIG. 14, the first region R1 on the facing surface 6c is divided into two by the second region R2 extending in parallel to the extending direction of the second wiring portion 6.

What is claimed is:

1. A coil component comprising:
an element body having a light transmissive property and including a plurality of laminated insulating layers; and
a coil conductor provided in the element body and having a visible surface facing a surface side of the element body and is visible from the surface,
wherein the coil conductor includes a main body and a colored layer having a color different from a color of the main body and provided on a part of the visible surface, and there exist a first region and a second region in the visible surface, the colored layer is provided at the first region and the main body is exposed from the colored layer at the second region.

2. The coil component according to claim 1, wherein the visible surface extends in one direction and the first region extends along an extending direction of the visible surface, and the second region extends in a direction intersecting the extending direction of the visible surface and crosses the first region.

3. The coil component according to claim 1, wherein the coil conductor has a plurality of the visible surfaces visible from the same surface of the element body,
wherein the first region and the second region exist in each of the plurality of the visible surfaces.

4. The coil component according to claim 3, wherein the plurality of the visible surfaces extend in parallel along one direction,
wherein the first regions extend along an extending direction of the visible surface in each of the plurality of the visible surfaces, and
wherein the second regions exist at positions corresponding to each of the plurality of the visible surfaces through the plurality of visible surfaces.

5. The coil component according to claim 1, wherein the visible surface extends in one direction,
wherein, in the visible surface, the first region extends along an extending direction of the visible surface and the second region extends along the extending direction of the visible surface and divides the first region.

6. The coil component according to claim 1, wherein the insulating layer constituting the element body is made of resin.

7. The coil component according to claim 1, wherein the colored layer is made of Cr.

8. The coil component according to claim 1, wherein the main body is made of Cu.

9. The coil component according to claim 1, wherein the coil conductor includes a wiring portion extending in a direction perpendicular to a lamination direction of the element body, and
wherein the wiring portion has the visible surface visible from the surface of the element body orthogonal to the lamination direction of the element body.

10. The coil component according to claim 9, wherein the element body has a mounting surface orthogonal to the lamination direction,
wherein the coil conductor includes a plurality of first wiring portions extending in parallel to the mounting surface, a plurality of second wiring portions extending in parallel to the mounting surface on a side farther from the mounting surface than the first wiring portions, and a plurality of pairs of pillar portions extending from both end portions of each of the plurality of second wiring portions toward the mounting surface along the lamination direction, and
wherein the wiring portion is the second wiring portion.
